(19) United States
(12) Patent Application Publication
(10) Pub. No.: US 2016/0169171 A1
(43) Pub. Date: Jun. 16, 2016

(54) MODULAR INTAKE MANIFOLD

(71) Applicant: Ford Global Technologies, LLC., Dearborn, MI (US)

(72) Inventors: Christopher William NEWMAN, Farmington Hills, MI (US); Milind B. KULKARNI, Canton, MI (US); Joshua D. SIMON, Sylvania, OH (US); Raymond HOST, Mount Clemens, MI (US)

(21) Appl. No.: 14/570,140

(22) Filed: Dec. 15, 2014

(51) Int. Cl. F02M 35/104; B60K 5/04; B60K 5/02; F02M 35/10; B60K 13/02

(52) U.S. Cl. CPC F02M 35/1042; F02M 35/10373; F02M 35/1034; F02M 35/10144; B60K 13/02; B60K 5/02; B60K 5/04

(57) ABSTRACT

An intake manifold is adapted for use with an engine in a front wheel drive vehicle and a rear wheel drive vehicle, for example, with both a transversely mounted and longitudinally mounted engine. The intake manifold is modular and includes a plenum body defining a first port and a second port. A series of runners are adapted to connect to the plenum body. A throttle body connector is adapted to connect to the first port and the second port based on the engine positioning in the vehicle. An end plate is adapted to connect to the first port and the second port.

### TECHNICAL FIELD

Various embodiments relate to an intake manifold for an internal combustion engine in a vehicle.

### BACKGROUND

An internal combustion engine may be used to propel a vehicle. Often, the same engine is used in multiple vehicle models, including a vehicle with front wheel drive and a vehicle with rear wheel drive. The positioning of the engine may change in the vehicle based on whether the vehicle is front or rear wheel drive to provide for the connection to the driveshaft and transmission and for packaging considerations. For example, an engine may be positioned and mounted transversely in a vehicle with front wheel drive, with the longitudinal axis of the engine generally perpendicular to the longitudinal axis of the vehicle. An engine may be positioned and mounted longitudinally in a vehicle with rear wheel drive, with the longitudinal axis of the engine generally parallel to the longitudinal axis of the vehicle. When the same engine, e.g. engine block and head, is used in both vehicle configurations, the intake manifold may be two separate designs, and the engine needs to be recalibrated for each intake manifold.

### SUMMARY

According to an embodiment, a vehicle is provided with an engine, and a modular intake manifold. The modular intake manifold has a plenum body defining first and second ports on opposed ends with substantially identical cross-sections, a throttle body connector, an end plate, and runners for connecting the intake manifold to the engine. The plenum body has a longitudinal axis generally parallel with a longitudinal axis of the engine, with each of the first and second ports sized to receive one of the throttle body connector and the end plate. The vehicle has a pair of tractive wheels receiving torque from the engine to propel the vehicle and positioned for one of front wheel drive and rear wheel drive. The throttle body connector is connected to the first port and the end plate is connected to the second port when the pair of tractive wheels are positioned for front wheel drive. The throttle body connector is connected to the second port and the end plate is connected to the first port when the pair of tractive wheels are positioned for rear wheel drive.

According to another embodiment, a modular intake manifold is provided and is adapted for use with a transversely mounted engine and a longitudinally mounted engine. The manifold is provided with a plenum body defining first and second ports on opposed ends of the body. Each port has substantially identical cross sections and is sized to receive one of a throttle body connector and an end plate. A series of runners is connected to the plenum body and is positioned between the first and second ports.

According to yet another embodiment, a method is provided for providing an intake manifold for an engine. Runners of an intake manifold are connected to a head of an engine transversely mounted in a vehicle. The intake manifold has a throttle body connector attached to one of a first end region and second end region of a plenum body and an end plate attached to the other of the first end region and second end region.

Various examples of the present disclosure have associated, non-limiting advantages, For example, by providing a modular intake manifold, all or a majority of the components of the intake manifold may be connected in various configurations to provide an intake manifold for an engine that is mounted in various positions within the vehicle, for example, longitudinally or transversely. By using the same base components in the intake manifold, the same engine map or calibration may be used with both a transversely mounted engine and a longitudinally mounted engine. Also, by using modular components, tooling and other associated engine development and production matters may be minimized or streamlined.

### BRIEF DESCRIPTION OF THE DRAWINGS

FIG. 1 illustrates a schematic of an internal combustion engine capable of employing various embodiments of the present disclosure;

FIG. 2 illustrates an exploded view of an intake manifold system according to an embodiment for use with the engine of FIG. 1;

FIG. 3 illustrates a schematic of a front wheel drive vehicle with the engine and intake manifold of FIGS. 1 and 2;

FIG. 4 illustrates a schematic of a rear wheel drive vehicle with the engine and intake manifold of the present disclosure; and

FIG. 5 illustrates a flow chart for a method of manufacturing and assembling the intake manifold of FIGS. 2-4 according to an embodiment.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

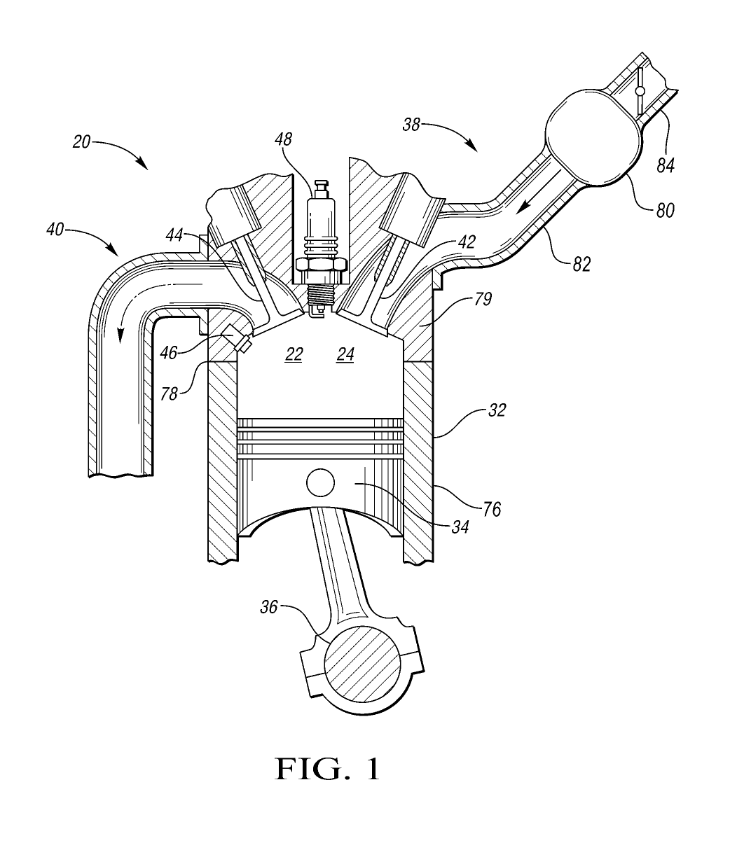

FIG. 1 illustrates a schematic of an internal combustion engine 20. The engine 20 has a plurality of cylinders 22, and one cylinder is illustrated. The engine 20 may have any number of cylinders 22, including three, four, six, eight, or another number. The cylinders may be positioned in various configurations in the engine, for example, as a V-engine, an inline engine, or another arrangement.

The engine 20 has a combustion chamber 24 associated with each cylinder 22. The cylinder 22 is formed by cylinder walls 32 and piston 34. The piston 34 is connected to a crankshaft 36. The combustion chamber 24 is in fluid communication with the intake manifold 38 and the exhaust manifold 40. An intake valve 42 controls flow from the intake manifold 38 into the combustion chamber 24. An exhaust valve 44 controls flow from the combustion chamber 24 to the exhaust manifold 40. The intake and exhaust valves 42, 44 may be operated in various ways as is known in the art to control the engine operation.

A fuel injector 46 delivers fuel from a fuel system directly into the combustion chamber 24 such that the engine is a direct injection engine. A low pressure or high pressure fuel injection system may be used with the engine 20, or a port injection system may be used in other examples. An ignition system includes a spark plug 48 that is controlled to provide energy in the form of a spark to ignite a fuel air mixture in the combustion chamber 24. In other embodiments, other fuel delivery systems and ignition systems or techniques may be used, including compression ignition.

The engine 20 includes a controller and various sensors configured to provide signals to the controller for use in controlling the air and fuel delivery to the engine, the ignition timing, the power and torque output from the engine, and the like. Engine sensors may include, but are not limited to, an oxygen sensor in the exhaust manifold 40, an engine coolant temperature, an accelerator pedal position sensor, an engine manifold pressure (MAP) sensor, an engine position sensor for crankshaft position, an air mass sensor in the intake manifold 38, a throttle position sensor, and the like.

In some embodiments, the engine 20 is used as the sole prime mover in a vehicle, such as a conventional vehicle, or a stop-start vehicle. In other embodiments, the engine may be used in a hybrid vehicle where an additional prime mover, such as an electric machine, is available to provide additional power to propel the vehicle.

Each cylinder 22 may operate under a four-stroke cycle including an intake stroke, a compression stroke, an ignition stroke, and an exhaust stroke. In other embodiments, the engine may operate with a two stroke cycle. During the intake stroke, the intake valve 42 opens and the exhaust valve 44 closes while the piston 34 moves from the top of the cylinder 22 to the bottom of the cylinder 22 to introduce air from the intake manifold to the combustion chamber. The piston 34 position at the top of the cylinder 22 is generally known as top dead center (TDC). The piston 34 position at the bottom of the cylinder is generally known as bottom dead center (BDC).

During the compression stroke, the intake and exhaust valves 42, 44 are closed. The piston 34 moves from the bottom towards the top of the cylinder 22 to compress the air within the combustion chamber 24.

Fuel is then introduced into the combustion chamber 24 and ignited. In the engine 20 shown, the fuel is injected into the chamber 24 and is then ignited using spark plug 48. In other examples, the fuel may be ignited using compression ignition.

During the expansion stroke, the ignited fuel air mixture in the combustion chamber 24 expands, thereby causing the piston 34 to move from the top of the cylinder 22 to the bottom of the cylinder 22. The movement of the piston 34 causes a corresponding movement in crankshaft 36 and provides for a mechanical torque output from the engine 20.

During the exhaust stroke, the intake valve 42 remains closed, and the exhaust valve 44 opens. The piston 34 moves from the bottom of the cylinder to the top of the cylinder 22 to remove the exhaust gases and combustion products from the combustion chamber 24 by reducing the volume of the chamber 24. The exhaust gases flow from the combustion cylinder 22 to the exhaust manifold 40 and to an after treatment system such as a catalytic converter.

The intake and exhaust valve 42, 44 positions and timing, as well as the fuel injection timing and ignition timing may be varied for the various engine strokes.

The engine 20 includes a cooling system to remove heat from the engine 20, and may be integrated into the engine 20 as a cooling jacket containing water or another coolant.

A head gasket 78 in interposed between the cylinder block 76 and the cylinder head 79 to seal the cylinders 22.

The intake 38 to the engine 20 includes a plenum 80 distributing intake gases to runners 82. The runners 82 provide the intake gases, including ambient air, exhaust gases from exhaust gas recirculation, etc. to the intake valves 42. A throttle valve 84 is provided to control the flow of intake gases to the plenum 80. The throttle valve 84 may be connected to an electronic throttle body for electronic control of the valve position. The intake 38 may be connected to an exhaust gas recirculation (EGR) system, a canister purge valve (CPV) and fuel system, a positive crankcase ventilation (PCV) system, a brake booster system, and the like. An air filter (not shown) may be provided upstream of the throttle valve 84.

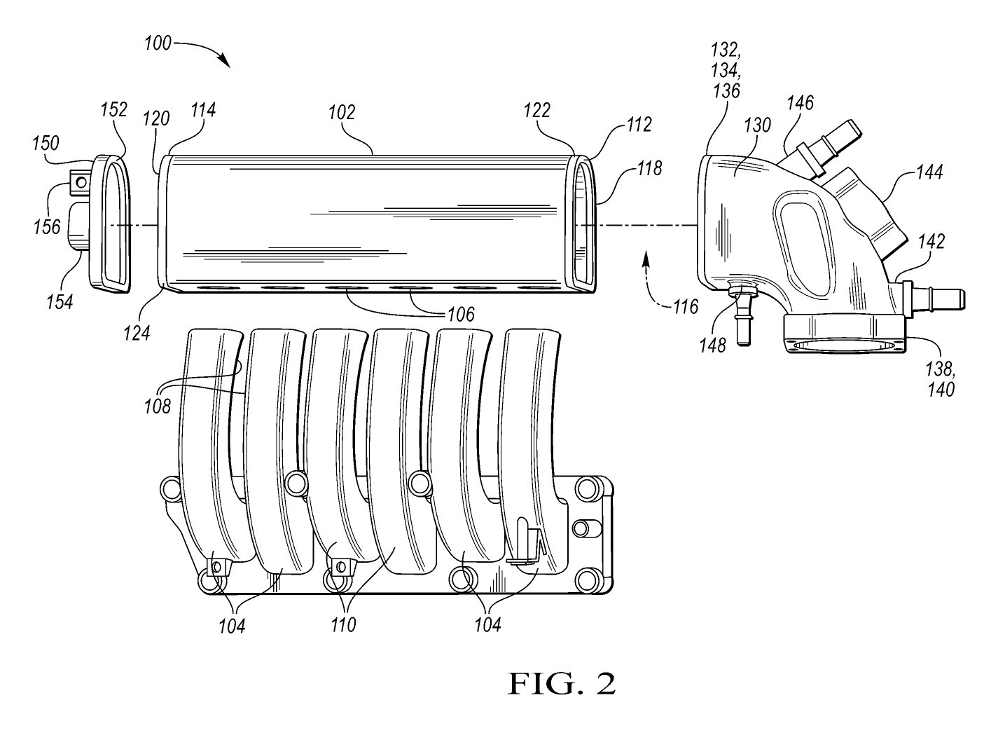

FIG. 2 illustrates an exploded view of an intake manifold system 100 according to an embodiment for use with the engine of FIG. 1. The intake manifold 100 is a modular system that allows for various separate components of the intake manifold to be positioned and assembled variably to form the manifold. By providing for multiple configurations with the same base components, the intake manifold 100 may be used with the same internal combustion engine mounted various ways in a vehicle. By providing for a modular intake manifold 100, only one set of tooling is needed to make all or a portion of the components of the intake manifold 100.

The intake manifold 100 may be assembled in multiple configurations based on the engine position and vehicle packaging considerations. For example, the components of the intake manifold 100 may be assembled in a first configuration for use with an engine that is mounted transversely in a front wheel drive vehicle. The same components of the intake manifold 100 may be assembled in a second configuration for use with the same engine that is mounted longitudinally in a rear wheel drive vehicle. As the intake manifold 100 provides generally the same geometry for intake gas flow in the various configurations, the engine may only need to be calibrated once, and the same engine maps or calibration tables may be used for the engine in multiple vehicle platforms, providing a more robust solution.

The intake manifold 100 has a plenum body 102. The plenum body 102 may be a “log” style plenum or another shape. The plenum body 102 is hollow and provides an internal volume for the intake gases to be distributed to the runners 104. The plenum 102 may be sized and shaped to be at a partial vacuum during engine operation. The engine may have direct fuel injection into the combustion chamber, in which case intake air and/or EGR gas may be provided to the engine. If the engine has a carburetor, the intake manifold and plenum may distribute an air and fuel mixture to the runners 104 and the combustion chambers.

The plenum body 102 has a series of apertures 106 sized to receive an end portion 108 of each of the runners 104. The apertures 106 may have a mounting flange or the like to provide a mating surface with the end portion 108 of the runners 104. In another embodiment, the plenum body 102 and runners 104 are integrally formed, or formed as shells and assembled.

The runners 104 have another end region 110 that connects to the intake ports of the engine to provide inlet gases through the intake valves to the combustion chambers of the engine. The runners 104 may be shaped in various ways as is known in the art for use with the engine. For example, the runners may be straight, curved, have various lengths, etc. based on the engine design. The runners 104 may be tuned to take advantage of the Helmholtz resonance effect.

The plenum body 102 has a first end region 112 and a second end region 114. The plenum body 102 extends along and provides a longitudinal axis 116 of the intake manifold 100. The first end region 112 defines a first port 118, opening, or aperture. The second end region defines a second port 120, opening, or aperture. The first and second ports 118, 120 may be sized to be equivalent to one another. The first and second ports 118, 120 may be spaced apart from one another along the longitudinal axis 116, and in one example, the longitudinal axis 116 extends through the first and second ports 118, 120. In one non-limiting example, the plenum body 102 may also or alternatively have a sensor mount (such as sensor mount 154) for a sensor such as an intake gas temperature sensor, a pressure sensor, or the like. The plenum body 102 may also have an attachment feature, such as attachment feature 156 described below, for use in connecting or supporting the intake manifold 100 with the engine and/or the vehicle.

The ports 118, 120 may vary in diameter or dimension from the plenum body 102, or may be generally the same diameter or dimension as the plenum body 102.

The first end region 112 and port 118 has a fitting 122, or a portion of a coupling or a connector. The second end region 114 and port 120 has a fitting 124, or a portion of a coupling or a connector. In one example, the edges of the ports or apertures 118, 120 themselves provide the fittings 122, 124. The fittings 122, 124 may be identical to one another to provide part of the modular function of the intake manifold 100.

The intake manifold 100 has a throttle body connector 130. The throttle body connector 130 is an attachment section to connect a throttle valve to the intake manifold 100. The throttle body connector 130 may be a secondary neck providing a restriction or a flow channel for the inlet gases from the throttle valve to the plenum 102. The connector 130 may be an elbow shaped connector as shown, a straight connector, or another shape.

The throttle body connector 130 has an end region 132 defining a port 134, opening, or aperture. The end region 132 and aperture 134 has a fitting 136, or another portion of a coupling or connector adapted to mate with the fitting 122 and the fitting 124 for connection to the plenum body 102. In one example, the edge of the port 134 or aperture provides the fitting 136.

The throttle body also has another end region 138 defining an port 140. The end region 138 is adapted to connect to a throttle valve or an electronic throttle body. An air filter or another intake component may be connected to the other side of the throttle valve.

The throttle body connector 130 may also define various ports for connection to engine or vehicle systems. An example of ports for a throttle body connector 130 are shown in FIG. 2; however, it is contemplated that the connector 130 may have a greater or fewer number or ports or sensor connections, and they may be arranged in various manners. In the example shown, the connector 130 has a brake booster port 142, an exhaust gas recirculation (EGR) housing mount or port 144, a connection port or mount 146 for positive crankcase ventilation (PCV) valve or system, and a connection port or mount 148 for a canister purge valve (CPV) or system. the arrangement of the ports or mounts may be based on their size and packaging considerations.

The intake manifold 100 also has an end plate or end cover 150. The end plate 150 that is used to cover and enclose the interior volume of the plenum body 102 by covering the port 118, 120 that is left uncovered after attachment of the throttle body connector 130. The end plate 150 has a fitting 152 or another portion of a coupling or connector adapted to mate with the fitting 122 and the fitting 124 for connection to the plenum body 102. In one example, the outer edge of the end plate 150 may provide the fitting 152. The fitting 152 of the end plate 150 and the fitting 136 of the throttle body connector 130 may be identical to one another to provide part of the modularity of the intake manifold.

The end plate 150 may also define various sensor mounts or ports for the intake manifold 100. In one non-limiting example, as shown, the end plate 150 has a sensor mount 154 for a sensor such as an intake gas temperature sensor, a pressure sensor, or the like. The end plate 150 may also have an attachment feature 156 for use in connecting or supporting the intake manifold 100 with the engine and/or the vehicle.

The throttle body connector 130 may be connected to either the fitting 122 of the first end region 112 or the fitting 124 of the second end region 114. The end plate is connected to the other of the fitting 122 of the first end region 112 or the fitting 124 of the second end region 114. Based on the engine configuration and layout in the vehicle, the throttle body connector 130 is selectively connected to either fitting 122, 124, and the end cover 150 is connected to the other of fitting 122, 124.

In one example, the fittings 122, 124 are male fittings, and the fittings 136, 152 are corresponding female fittings. In another example, fittings 122, 124 are female fittings, and the fittings 136, 152 are corresponding male fittings. In a further example, the fittings 122, 124, 136, 152 may be flush and abut one another. The fittings may be various types of fittings as are known in the art. For example, the fittings may be a sleeve connection, with an inner male sleeve fitting received by a female outer sleeve fitting. In other examples, the fittings are screw fittings, snap fittings, or the like. In alternative embodiments, the fittings are flanges that are connected to one another by a fastener, such as one or more bolts, or a cam locking mechanism. The fittings may have a gasket or another sealing member positioned between them to prevent intake gases from escaping the plenum body 102. Based on the materials used in the intake manifold, the components may be connected to one another using various manufacturing techniques. For example, the components may be welded, friction welded, bonded with an adhesive, or the like.

In other embodiments, the intake components of manifold system 100 may include an additional, second throttle body connector or another component for use in some vehicle configurations. For example, the intake manifold system may include a first throttle body connector and a second throttle body connector that vary from one another while the plenum body, the runners, and the end plate remain common elements. A different throttle body connector may be used based on the packaging space and geometry available in a specific engine mounting configuration in a vehicle, or to provide greater or fewer ports or sensor mounts.

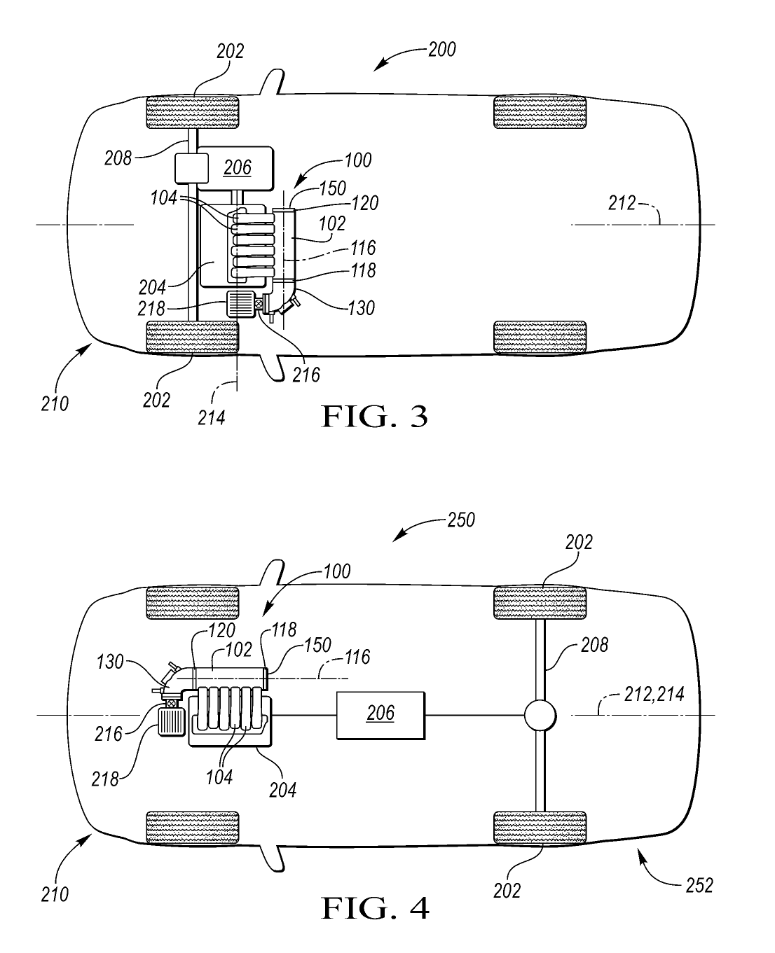

According to an example, a front wheel drive vehicle with a transversely mounted engine is illustrated in FIG. 3. The vehicle 200 has a pair of traction wheels 202 that are used to propel the vehicle. An engine 204 is connected to a transmission 206 and the axle 208 to provide torque to the wheels 202. The front of the vehicle is indicated by arrow 210. The vehicle 200 has a longitudinal axis 212. The engine 204 also has a longitudinal axis 214. As can be seen from the figure, the longitudinal axis 214 of the engine is generally transverse or perpendicular to the longitudinal axis 212 of the vehicle for the front wheel drive vehicle.

Runners 104 of the intake manifold 100 are connected to the intake ports of the engine 204. The throttle body connector 130 is connected to the first end region 112 of the plenum body 102. The end plate 150 is connected to the other end 114 of the plenum body 102. A throttle valve 216 is connected to the throttle body connector 130. An air filter 218 is connected to the throttle valve 216.

The longitudinal axis 116 of the plenum body 102 and of the intake manifold 100 is generally parallel with the engine longitudinal axis 214. The longitudinal axis 116 of the plenum body 102 and of the intake manifold 100 is generally transverse or perpendicular to the vehicle longitudinal axis 212.

In another example, a rear wheel drive vehicle with a longitudinally mounted engine is illustrated in FIG. 4. Reference numbers for elements that are the same or similar to those shown in FIGS. 2 and 3 remain the same. The vehicle 250 has a pair of traction wheels 202 that are used to propel the vehicle. An engine 204 is connected to a transmission 206 and the axle 208 to provide torque to the wheels 202. The front of the vehicle is indicated by arrow 210, and the rear of the vehicle is indicated by arrow 252. The vehicle 200 has a longitudinal axis 212. The engine 204 also has a longitudinal axis 214. As can be seen from the figure, the longitudinal axis 214 of the engine is generally parallel to the longitudinal axis 212 of the vehicle for the rear wheel drive vehicle. The longitudinal axis 214 of the engine may be coincident with the longitudinal axis 212 of the vehicle as shown. In other examples, the longitudinal axis 214 of the engine may be offset from the longitudinal axis 212 of the vehicle based on the positioning of the engine 204 in the vehicle 250.

The components of the intake manifold 100 are assembled in a different configuration or order compared to FIG. 3. Runners 104 of the intake manifold 100 are connected to the intake ports of the engine 204. The throttle body connector 130 is connected to the second end region 114 of the plenum body 102. The end plate 150 is connected to the other end 112 of the plenum body 102. A throttle valve 216 is connected to the throttle body connector 130. An air filter 218 is connected to the throttle valve 216.

The longitudinal axis 116 of the plenum body 102 and of the intake manifold 100 is generally parallel with the engine longitudinal axis 214. The longitudinal axis 116 of the plenum body 102 and of the intake manifold 100 is generally parallel to the vehicle longitudinal axis 212.

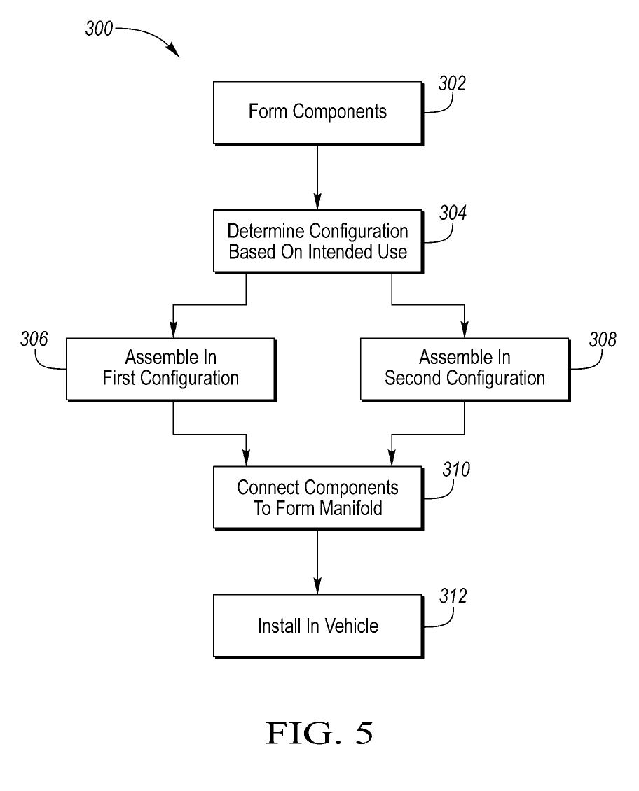

A flow chart representing a method 300 of assembling a modular intake manifold for an engine according to the present disclosure is illustrated in FIG. 5. The intake manifold may be the intake manifold 100 as described above. In other embodiments, the method 300 may include a greater or fewer number of steps, and various steps may be performed sequentially or in parallel with one another. The steps in the method 300 may also be ordered differently from the illustrated method in other embodiments.

The modular plenum body, runners, throttle body connector and end plate components are formed at block 302. The components may be formed separately from one another, and based on the materials used; each component may have multiple sub-components that are sub-assembled to form the component. The components may be formed from a metal, such as an aluminum alloy or another suitable metal, in a process such as stamping, or the like from a sheet metal stock. The components may also be formed from a plastic, fiber reinforced plastic, or composite material in a process such as injection molding, thermoforming, vacuum forming, blow molding etc.

At step 302, the plenum body is formed with the first and second ports each having a first fitting. The end plate is formed with a second fitting adapted to mate with the first fitting. The throttle body connector is also formed with the second fitting which is adapted to mate with the first fitting.

At block 304, the planned mounting and positioning of the engine in a vehicle is determined to provide the configuration and layout for the intake manifold. For example, the intake manifold may be planned for use in a vehicle with the engine mounted either longitudinally or transversely. Based on the desired layout of the engine and the intake manifold, the components are assembled in various configurations, for example at blocks 306, 308.

At block 306, the plenum body, runners, throttle body connector, and end plate are assembled or positioned relative to one another in a first configuration. The first configuration may be for use with a transversely mounted engine as shown in FIG. 3 or another selected configuration. For example, the throttle body connector may be connected to a first end region of the plenum body and the end plate may be connected to a second end region of the plenum body for use with an engine transversely mounted in a vehicle.

At block 308, the plenum body, runners, throttle body connector, and end plate are assembled or positioned relative to one another in a second configuration. The second configuration may be for use with a longitudinally mounted engine as shown in FIG. 4 or another selected configuration. For example, the throttle body connector may be connected to a second end region of the plenum body and the end plate may be connected to a first end region of the plenum body for use with an engine longitudinally mounted in a vehicle.

At block 310, the components are fastened together. Based on the materials used, various methods of attaching the components are contemplated. For example, with plastic components, the intake manifold system may be friction welded together or adhesively bonded. For metal components, the intake manifold system may be welded together.

At block 312, the intake manifold is connected to the engine and the vehicle in a final assembly step.

Various examples of the present disclosure have associated, non-limiting advantages, For example, by providing a modular intake manifold, all or a majority of the components of the intake manifold may be connected in various configurations to provide an intake manifold for an engine that is mounted in various positions within the vehicle, for example, longitudinally or transversely. By using the same base components in the intake manifold, the same engine map or calibration may be used with both a transversely mounted engine and a longitudinally mounted engine. Also, by using modular components, tooling and other associated engine development and production matters may be minimized or streamlined.

While exemplary embodiments are described above, it is not intended that these embodiments describe all possible forms of the invention. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A vehicle comprising:
an engine;
a modular intake manifold comprising a plenum body defining first and second ports on opposed ends with substantially identical cross-sections, a throttle body connector, an end plate, and runners for connecting the intake manifold to the engine, the plenum body having a longitudinal axis generally parallel with a longitudinal axis of the engine, each of the first and second ports sized to receive one of the throttle body connector and the end plate; and
a pair of tractive wheels receiving torque from the engine to propel the vehicle, the pair of tractive wheels positioned for one of front wheel drive and rear wheel drive;
wherein the throttle body connector is connected to the first port and the end plate is connected to the second port when the pair of tractive wheels are positioned for front wheel drive; and
wherein the throttle body connector is connected to the second port and the end plate is connected to the first port when the pair of tractive wheels are positioned for rear wheel drive.

2. The vehicle of claim 1 wherein the longitudinal axis of the manifold is generally transverse to a longitudinal axis of the vehicle in front wheel drive; and
wherein the longitudinal axis of the manifold is generally parallel to a longitudinal axis of the vehicle in rear wheel drive.

3. A modular intake manifold adapted for use with a transversely mounted engine and a longitudinally mounted engine, the manifold comprising:
a plenum body defining first and second ports on opposed ends of the body, each port with substantially identical cross sections and sized to receive one of a throttle body connector and an end plate; and
a series of runners connected to the plenum body and positioned between the first and second ports.

4. A modular intake manifold of claim 3 further comprising:
a throttle body connector; and
an end plate.

5. The intake manifold of claim 4 wherein the throttle body connector is connected to the first port of the plenum body and the end plate is connected to the second port of the plenum body in a transversely mounted engine.

6. The intake manifold of claim 4 wherein the throttle body connector is connected to the second port of the plenum body and the end plate is connected to the first port of the plenum body in a longitudinally mounted engine.

7. The intake manifold of claim 4 wherein the throttle body connector defines a third port and a fourth port, the third port adapted to connect to one of the first and second ports, the fourth port adapted to connect to an electronic throttle body.

8. The intake manifold of claim 7 wherein the throttle body connector is an elbow connection.

9. The intake manifold of claim 7 wherein the throttle body connector defines at least one of an exhaust gas recirculation mount, a positive crankcase ventilation mount, and a canister purge valve mount.

10. The intake manifold of claim 4 wherein the throttle body connector is a first throttle body connector, the intake manifold further comprising:
a second throttle body connector adapted to connect to the first port and the second port.

11. The intake manifold of claim 4 wherein the end plate defines a sensor housing.

12. The intake manifold of claim 3 wherein the first port and the second port are spaced apart along a longitudinal axis of the plenum body.

13. The intake manifold of claim 12 wherein the longitudinal axis of the plenum body extends through the first and second ports.

14. The intake manifold of claim 3 wherein the first port and second port are each provided with a first fitting; and
wherein the throttle body and the end plate are each provided with a second fitting adapted to mate with the first fitting.

15. The intake manifold of claim 14 wherein the first fitting is one of a male and a female connector, and wherein the second fitting is the other of the male and the female connector.

16. The intake manifold of claim 15 wherein the male fitting is an inner sleeve and the female fitting is an outer sleeve.

17. A method of providing an intake manifold for an engine, the method comprising:
connecting runners of an intake manifold to a head of an engine transversely mounted in a vehicle, the intake manifold having a throttle body connector attached to one of a first end region and second end region of a plenum body and an end plate attached to the other of the first end region and second end region.

18. The method of claim 17 further comprising connecting runners of the intake manifold to the head of the engine longitudinally mounted in the vehicle, the intake manifold having the end plate attached to one of the first end region and second end region of the plenum body and the throttle body connector attached to the other of the first end region and the second end region.

19. The method of claim 17 further comprising forming the intake manifold by:
forming the plenum body with a first port and a second port, the first and second ports having a first fitting;
forming the end plate with a second fitting adapted to mate with the first fitting; and
forming the throttle body connector with the second fitting.

20. The method of claim 19 further connecting the throttle body connector and the end plate to the plenum body using at least one of friction welding, welding, mechanically fastening, and press fitting.
